(19) United States
(12) Patent Application Publication
(10) Pub. No.: US 2008/0091368 A1
(43) Pub. Date: Apr. 17, 2008

(54) Method Of Determining An Autocorrelation Function

(76) Inventors: Francois Lequeux, Paris (FR); Julien Lopez-Rios, La Tronche (FR)

Correspondence Address: Howard IP Law Group, P.O. Box 226, Fort Washington, PA, 19034, US

(21) Appl. No.: 11/587,560

(22) PCT Filed: Apr. 22, 2005
(86) PCT No.: PCT/FR05/50273

§ 371 Date: Jul. 5, 2007

(30) Foreign Application Priority Data
Apr. 27, 2004 (FR) 0450799

(51) Int. Cl. G06F 17/00

(52) U.S. Cl. 702/77

(57) ABSTRACT

A method for determining the autocorrelation function q(τ) of an optical signal, including the steps of: determining the times (ti) of occurrence of pulses corresponding to photons: calculating, for a predetermined set of pulses (w), the function s(w)=Σᵢ^{e}^{^{−jwti}}, where e−jwti=coswti+jsinwti, the summing-up being performed over all the received pulses determining square S(w) of the module of function s(w), and calculating the Fourier transform g(τ) of power spectrum S(w) for a predetermined set of time interval values.

The present invention relates to a correlator enabling determination of the autocorrelation function of a light signal in the context of measurements, for example, in fluorescent spectroscopy, in Raman spectroscopy, or by quasi-elastic light scattering (simple or multiple). In this context, it is desired to determine the autocorrelation function of a signal re-emitted or diffused by a medium containing particles or molecules lit by a light source. This function especially enables characterizing the mobility of the particles or molecules in the lit medium.

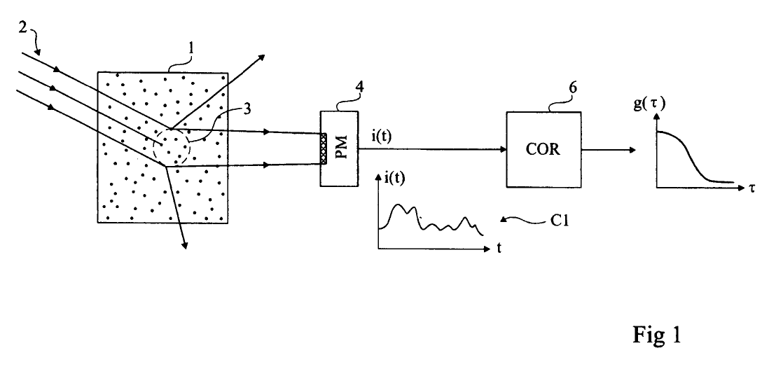

FIG. 1 is a diagram in the form of blocks of a fluorescence correlation spectroscopy assembly. In a vessel 1 is placed a solution containing particles which are desired to be characterized. A laser beam 2 stimulates the particles located in a small volume 3 of the solution. The lit particles substantially re-emit in all directions. A photoreceiver (photoelectric multiplier) 4 captures part of the re-emitted light and provides an electric signal i(t), an example of which is illustrated in curve C1. This electric signal is received by a correlator 7 which calculates the autocorrelation function:
g(τ)=<i(t)*i(t+τ)>
of intensity i(t) of the light signal for various values of time interval τ, < > representing a time average.

The usual general shape of the autocorrelation function is shown in FIG. 1. The more the autocorrelation function keeps a high value for significant time intervals τ, the stabler the lit area, and conversely.

The most currently used correlators implement a so-called “multi-tau” algorithm developed by Klaus Schätzel in 1975. This type of correlator enables direct calculation of the autocorrelation function of a signal by performing the calculations along the acquisition of the signal representative of the intensity of the received light signal. Such correlators are however rather unsatisfactory when the analyzed light signal exhibits a low intensity, the signal-to-noise ratio becoming critical. Further, the very principle of this algorithm results in that only an approximate of the wanted autocorrelation function is obtained.

Another calculation mode of the autocorrelation function is described in article “Multichannel scaler for general statistical analysis of dynamic light scattering” by R. Sprik and E. Baaij, published in “REVIEW OF SCIENTIFIC INSTRUMENTS”, June 2002. The calculation of autocorrelation function g(τ) is performed according to a “double Fourier transform” method. First, power spectrum S(w) of signal i(t) is calculated, S(w) being equal to the squared module of Fourier transform s(w) of signal i(t). Second, the Fourier transform of power spectrum S(w), which is function g(τ), is calculated. This method provides an exact value of the autocorrelation function but also has the disadvantage of being inefficient when the analyzed light signal exhibits a low intensity. Further, it requires the performing of a significant number of calculations.

An object of the present invention is to provide a correlator capable of accurately calculating an autocorrelation function within a reduced time, this correlator being particularly well adapted to a light signal of low intensity.

Another object of the present invention is to provide such a correlator requiring a decreased space for storing the signal representative of the studied light signal.

To achieve these objects, the present invention provides a method for determining the autocorrelation function g(τ) of an optical signal, comprising the steps of:
determining the times (tᵢ) of occurrence of photons;
calculating, for a predetermined set of pulses (w), function
   s(w)=Σᵢe^{-jwti}
   where e^{-jwt}i=coswtᵢ+jsinwtᵢ, the summing-up being performed over all the received pulses,
determining square S(w) of the module of function s(w), and
calculating the Fourier transform g(τ) of power spectrum S(w) for a predetermined set of time interval values.

According to an embodiment of the present invention, the times (tᵢ) of occurrence of the pulses are determined from a reference time or from the time of occurrence of the pulse preceding the considered pulse, in the form of a number (nᵢ) of cycles of a reference clock.

According to an embodiment of the present invention, said pulses correspond to the output signal of a photoreceiver receiving a photon sequence.

According to an embodiment of the present invention, the calculation of function s(w) is performed for a set of logarithmically-distributed time interval values.

According to an embodiment of the present invention, the calculation of Fourier transform g(τ) is performed for a set of logarithmically-distributed pulses.

The present invention also provides a correlator implementing the above method.

The foregoing objects, features, and advantages, as well as others, of the present invention will be discussed in detail in the following non-limiting description of specific embodiments in connection with the accompanying drawings, among which:

FIG. 1 is a previously described diagram of a fluorescence correlation spectroscopy system;

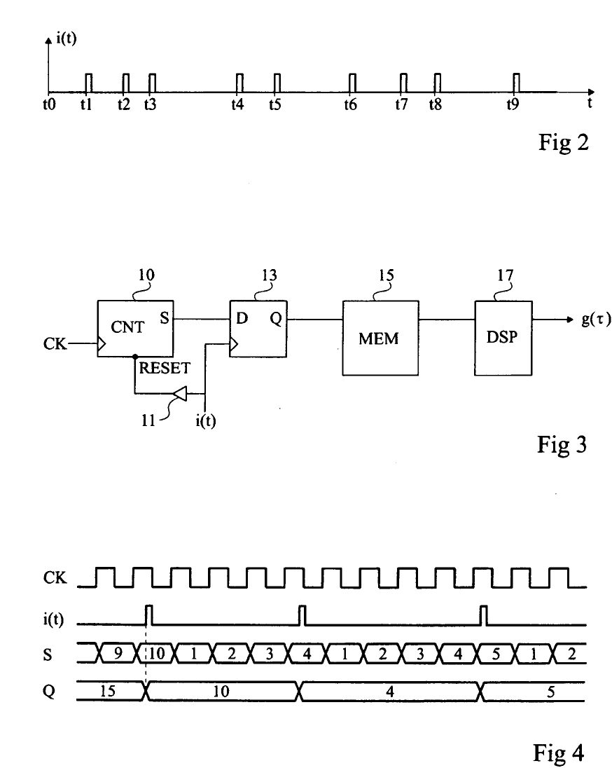

FIG. 2 is a diagram illustrating a signal representative of the intensity of a light signal along time;

FIG. 3 is a diagram of a correlator according to the present invention; and

FIG. 4 is a timing diagram illustrating the values taken by various signals of the circuit of FIG. 3.

The present invention is based on an analysis of the conventional Fourier transform calculation mode in the above-mentioned “double Fourier transform” method.

In the following part I, the number of calculation steps necessary to calculate the Fourier transform of signal i(t) will be evaluated.

It will then be shown in part II that, in the context of experiments such as of fluorescence correlation spectroscopy, Raman spectroscopy, or quasi-elastic light scattering (simple or multiple), conversely to an established prejudice, it is more economical in terms of calculation time to perform a Fourier transform calculation for all the received photons. It will be shown that this further results in more accurate results, especially in the vicinity of low correlation time values.

Thus, the present invention uses the “double Fourier transform” method and provides modifying this method to decrease the necessary amount of memory and the number of calculation steps, whereby this method can be implemented by a simplified correlator.

I. Analysis of a Conventional Fourier Transform Calculation

The determination of the autocorrelation function by the above-mentioned “double Fourier transform” comprises first calculating power spectrum S(w) of signal i(t) over a predetermined range of pulse values (w). Power spectrum S(w) is equal to the squared module of Fourier transform s(w) of signal i(t). For a given pulse w, s(w) is provided by:

$$s ( w ) = {\int }_{- ∞}^{∞} i ( t ) {ⅇ}^{- j wt} ⅆ t$$

where j is the complex variable.

In practice, for each value of w, a sum over a number of times tᵢ is calculated:
s(w)=Σᵢi(tᵢ)e^{-jwti} (1)

Times tᵢ correspond to time intervals regularly distributed along time over a measurement period and values i(tᵢ) correspond to averages calculated on these time intervals from samples of signal i(t) obtained at high frequency. For example, signal i(t) is sampled over a time period T of 10 s, at each cycle of a clock CLK of high frequency, for example, 100 MHz, which provides 10⁹ samples over time period T. Such a sampling is necessary to have a good image of signal i(t). However, sum (1) cannot reasonably be performed over as high a number of samples and will have to be limited to a sum over for example 10⁶ sampling values. Each of the sampling values corresponds, in this example, to the average or to the sum of the values of 1,000 successive samples. Thus, for each value wⱼ of w, a sum of 10⁶ multiplications of i(tᵢ) by wⱼ must be calculated and, if 10⁶ values of w are desired to be obtained, these operations will have to be performed 10⁶ times. The calculation of s(w) thus implies calculating 10¹² sums of multiplications. It should further be noted that the selection of a limited number of sampling values results in a loss of accuracy.

To decrease the calculation time, “fast” calculation algorithms such as the well-known fast Fourier transform algorithm may be used.

Given that the frequency corresponding to the sampling time intervals is, in the context of the above example, equal to 10⁵ Hz, s(w) will be defined for values of w (in radians/s) varying between 2π/T=π (if duration T of the experiment is 2 s) and 2π10⁵/2. Accordingly, g(τ) will be defined between 2.10⁻⁵ s and 1 s by increments of 2.10⁻⁵ s. This numerical example is intended to underline that the smallest value of g (τ) and the interval between the first points of g(τ) are a direct function of the sampling frequency, which is generally much lower than the sampling frequency.

II. Calculation of the Fourier Transform According to the Invention

The present invention provides performing the Fourier transform calculation, not for regularly-distributed time intervals, but for all the incident photons. It will be shown that, conversely to an established prejudice, in the context of the envisaged application, this decreases the number of calculation steps and provides an absolutely accurate result.

Several authors have observed that, in the field of fluorescence correlation spectroscopy and the like, one of the problems lies in the very small number of available photons. This has for example been underlined in John S. Eid et al's article, published in the Review of Scientific Instruments, volume 71, No 2, February 2000. This is also underlined in Sprik et al's above-mentioned article published in the same review in 2002. More specifically, in Eid's article, it is indicated that the number of photons which appear in a measurement interval, for example, 10 s, is much lower than the number of sampling pulses, for example 10⁹ in the case of a sampling at 100 MHz, this number of photons being for example on the order of 100,000. This figure is confirmed in Sprike et al's above-mentioned article. Due to this number of photon, Eid provides, rather than performing a sampling and measuring for each sampling window whether a photon is present or not, only keeping in memory the times at which the photons appear. It should further be noted that it is possible to measure either the times at which photons appear from an original time, or the time intervals between photon appearances. Thus, in the case where only 100,000 photons appear, only 10⁵ points instead of 10⁹ will be measured in the case of a sampling at 100 MHz for a 10-second time period. This spares room in the memory. However, none of the authors having noted this low number of photons has deduced consequences therefrom as to the way to calculate the Fourier transform, and double Fourier transform calculations have kept on being performed in the above-mentioned conventional way.

According to the present invention, it should be noted that, signal i(t) being formed of a sequence of pulses having an insignificant amplitude and width,

$$s ( w ) = {\int }_{- ∞}^{∞} i ( t ) {ⅇ}^{- j wt} ⅆ t$$

is strictly identical to:
s(w)=Σᵢe^{-jwti} (2)
where e^{-jwt}i=coswtᵢ+jsinwtᵢ, the sum being performed over all the received photons.

Formula (2) enables much simpler and faster calculation than a normal Fourier transform calculation of signal i(t) according to formula (1).

Thus, for the Fourier transform calculation, for each value wⱼ of w, the values of sinwt and of coswt are calculated or more currently searched for in a table, and these values are directly used, given that they are assigned a constant multiplication coefficient, equal to 1. Thus, according to the present invention, the number of performed calculations, which is limited to the number of received photons, is decreased, and each calculation is simpler since it only comprises a value of coswⱼt or of sinwⱼt with no multiplication coefficient. Thus, not only is the number of operations smaller but, further, each elementary operation is simpler.

For example, if signal i(t) is sampled over a 10-s time period T, at 100 MHz, and 10⁵ photons/s are received, a sum of 10⁶ values must be calculated for each value wⱼ or w and, if 10⁶ values of w are desired to be obtained, this operation will have to be performed 10⁶ times. The calculation of s(w) thus only implies calculating 10⁶ sums instead of 10⁶ sums of multiplications by the conventional method. The method according to the present invention requires a still smaller number of operations when the number of photons decreases, while keeping a strict character, the performed calculation implying no approximation step.

Further, the inventors have noted that it is possible to obtain a very correct representation of S from a set of values S(wₗ) to S(wₖ) calculated for a set of pulses wₗ to wₖ. The use of a sequence of logarithmically-distributed pulses wₗ to wₖ provides a quite satisfactory representation of s. The selection of a logarithmic sequence of pulses enables significantly decreasing the number of calculations of values of spectrum s.

The function s′(w) obtained by taking values s(wₗ) to s(wₖ) and by performing a linear extrapolation between each of these values is thus determined.

The Fourier transform g(τ) of S′(w) is then calculated. This Fourier transform is preferably calculated for a sequence of logarithmically-distributed values of τ by noting that, in the desired function, the points corresponding to the high values of τ for which the value of g(τ) is low are less interesting. The real and imaginary values of g(τ) will preferably be calculated by the following expressions:
gᵣₑₐₗ(τ)=Σ_{w}S(w)·coswτ
gᵢₘ(τ)=Σ_{w}S(w)·sinwτ

An additional advantage of the present invention is that the smallest value of g(τ) is now defined according to the real sampling frequency, on the order of 100 MHz, that is, this value will be on the order of 10⁻⁸ second instead of 10⁻⁵ second, as explained previously for the conventional case with a same basic sampling frequency. A much greater accuracy of function g(τ) is thus obtained in the vicinity of the small values of τ, which is the area in which this accuracy is desired to be large.

FIG. 2 shows the real outlook of signal i(t), present in the form of a sequence of arrival of photons spaced apart from one another.

FIG. 3 is a diagram in the form of blocks illustrating an embodiment of the above-mentioned memorization method. FIG. 4 illustrates signals appearing at various points of the circuit of FIG. 4.

In FIG. 3, a counter CNT 10 receives a clock signal (for example, 100 MHz) and, on its reset input, signal i(t) inverted by an inverter 11. Signal i(t) is also applied to the clock input of a set of registers 13. Output S of counter 10 is connected to the D input of the set of registers 13. Thus, for each rising edge of signal i(t), the counter value is temporarily memorized in registers 13. Little after each memorization in registers 13, the stored value is written into a memory 15. A specific calculator, DSP, 17, calculates function g(τ) from the memorized values, as discussed previously. The operation of this circuit is better understood by referring to FIG. 4 in which examples of timing diagrams of signals CK, i(t), S, and Q are indicated for successive intervals between photons of 15 clock pulses, 10 clock pulses, 4 clock pulses, and 5 clock pulses.

Of course, various conventional optimizations of the previously-described method for determining the autocorrelation function may be used while remaining within the context of the present invention.

1. A method for determining the autocorrelation function g(τ) of an optical signal, comprising the steps of:
determining the times (tᵢ) of occurrence of pulses corresponding to photons;
calculating, for a predetermined set of pulses (w), the function
s(w)=Σᵢe^{-jwti}
where e^{-jwt}i=coswtᵢ+jsinwtᵢ, the summing-up being performed over all the received pulses
determining square S(w) of the module of function s(w), and
calculating the Fourier transform g(τ) of power spectrum S(w) for a predetermined set of time interval values.

2. The method of claim 1, in which the times (tᵢ) of occurrence of the pulses are determined from a reference time or from the time of occurrence of the pulse preceding the considered pulse, in the form of a number (nᵢ) of cycles of a reference clock (CLK).

3. The method of claim 1, in which said pulses correspond to the output signal of a photoreceiver receiving a photon sequence.

4. The method of claim 2, in which the calculation of function s(w) is performed for a set of logarithmically-distributed time interval values.

5. The method of claim 2, in which the calculation of Fourier transform g(τ) is performed for a set of logarithmically-distributed pulses.

6. A correlator implementing the method of claim 1 made in the form of an integrated circuit.
